(19) United States
(12) Patent Application Publication
(10) Pub. No.: US 2023/0046271 A1
(43) Pub. Date: Feb. 16, 2023

(54) ENERGY-EFFICIENT DIRECT CO2 CAPTURE SYSTEM FROM AIR FOR HIGH-PURITY CO2 RECOVERY

(71) Applicant: University of Cincinnati, Cincinnati, OH (US)

(72) Inventors: Joo-Youp Lee, Cincinnati, OH (US); Aashish Priye, Cincinnati, OH (US)

(21) Appl. No.: 17/884,036

(22) Filed: Aug. 9, 2022

Related U.S. Application Data
(60) Provisional application No. 63/230,878, filed on Aug. 9, 2021.

(51) Int. Cl. B01D 53/04; B01D 53/62; B01J 20/20; B01J 20/10; B01J 20/26; B01J 20/28; B01J 20/34; B01D 53/96

(52) U.S. Cl. CPC B01D 53/0407; B01D 53/62; B01J 20/20; B01J 20/103; B01J 20/262; B01J 20/28042; B01J 20/3466; B01D 53/96; B01J 20/28004; B01D 2257/504; B01D 2253/25; B01D 2253/106; B01D 2253/102; B01D 2253/202; B01D 2253/304; B01D 2253/3425

(57) ABSTRACT

The present disclosure concerns systems and sorbents for the removal of carbon dioxide from ambient air. In some aspects, the system includes a wind collector, a body and an outlet. The body has a monolith or platforms dispersed therein, surfaces of which are at least partially coated in a sorbent, such that passing ambient air that contacts the sorbent, thereby allowing for the removal of carbon dioxide therefrom. Sorbents of the present disclosure include substrates that are hybrids of a silica, optionally with a carbonaceous material, and an epoxy-modified aminopolymer.

### CROSS-REFERENCE TO RELATED APPLICATIONS

The present application claims priority to U.S. Provisional Patent Application 63/230,878, filed Aug. 9, 2021, the content of which is hereby incorporated by reference in its entirety.

### TECHNICAL FIELD

The present invention relates to carbon dioxide (CO₂) capture systems and substrates that are useful therein.

### BACKGROUND

Contacting ambient air with a sorbent to capture CO₂ has been demonstrated and practiced in various systems including submarines and spaceships. Among other challenges, the low concentration of CO₂ requires a large amount of air to be moved through the sorbent. Thus, successful CO₂ capture from ambient air requires an engineered structure that can effectively channel air to the sorbent surface either through machinery (active flow) or natural processes such as wind (passive flow). Direct air capture (DAC) via fanning air has been demonstrated before but is energetically limited and maintaining a pressure drop of ˜100 Pa requires ˜6 kJ/mol of CO₂. Air can also be passively driven by natural processes such as wind, thermal convection, or wind-driven pressure gradients. However, harnessing this has additional challenges, such as controlling the speed and direction of wind. Passive air capture systems have been used to capture CO₂, albeit only in open air flow format without any wind capture channel to optimize the flow over the sorbent. Passive wind capture systems have been part of traditional architectures for centuries and is a common feature in Middle Eastern architecture. Their primary objective is to provide efficient ventilation and cooling inside buildings and homes. However, no air contactor has been designed that harnesses passive wind to optimize air flow around sorbent beds in order to maximize CO₂ capture.

Current DAC technologies with both aqueous solution-based and solid sorbents have to date revealed limitations in lacking efficiency and cost. Current systems have a high cost for every tonne of CO₂ extracted while also requiring high amounts of energy to regenerate the sorbent. For example, alkaline solution-based absorption processes including calcium hydroxide, sodium hydroxide, and potassium hydroxide were studied for DAC and resulted in a levelized cost in the range from $94 to $232/tonne of CO₂ (tCO₂), with a regeneration energy of 6.57-8.81 GigaJoules(GJ)/tCO₂. Previous studies on PEI/silica sorbent similarly revealed major limitations on oxidative and thermal degradation and CO₂ purity for desorption. For example, a lab-scale fluidized-bed reactor for DAC estimated a cost of $108/tCO₂ with 6.6 GJ/tCO₂ required for N₂ desorption. In order to effectively address the problem, the cost needs to be reduced and the energy for regeneration needs to be reduced. Thus, a need exists for a sorbent and a system to efficiently draw CO₂ by DAC.

### SUMMARY

The present disclosure sorbents and systems for the removal of carbon dioxide from ambient air.

In some aspects, the present disclosure concerns a sorbent for carbon dioxide removal from ambient air that is of silica, a carbonaceous material, and an epoxy modified aminopolymer. In some aspects, the silica is a porous silica. In some aspects, the silica is a combination of fumed silica and colloidal silica. In some aspects, the weight ratio of fumed silica to colloidal silica is of from 80:20 to 99:1. In certain aspects, the weight ratio of fumed silica to colloidal silica is 95:5.

In some aspects, the carbonaceous material is selected from graphite, graphene, coal, coke, nanotubes, fullerenes, and activated carbon. In certain aspects, the carbonaceous material is graphite. In some aspects, the carbonaceous material is from 1 to 15 wt % of the sorbent.

In some aspects, the epoxy modified aminopolymer includes an epoxy moiety selected from 1,2 epoxypentane, 1,2 epoxyhexane, 1,2 epoxypropane (EP) or 1,2 epoxybutane (EB) and an aminopolymer selected from pentaethylene hexamine (PEHA) or polyethylenimine (PEI).

In some aspects, the silica is from 20 to 80 wt % of the sorbent. In some aspects, the epoxy modified aminopolymer is from 20 to 80 wt % of the sorbent. In some aspects, the epoxy modified aminopolymer is PEI, wherein the PEI has a molecular weight from 100 to 2000 daltons.

In some aspects, the sorbent has a mean particle size of 10 to 300 μm.

In some aspects, the sorb ent is of 1 to 15 wt % graphite and the epoxy-modified aminopolymer is selected from EB-PEI, EB-PEHA, EP-PEI, EP-PEHA, or any combination thereof.

In some aspects the present disclosure concerns methods for removing CO₂ from ambient air comprising providing a flow of ambient air across the sorbents disclosed herein. In some aspects, the present disclosure concerns methods for regenerating the sorbents disclosed herein by heating the sorbent to above 70° C. at below 0.9 atm and flowing CO₂ or steam across the sorbent.

In some aspects, the present disclosure concerns a system for removing CO₂ from ambient air, through the application of the sorbents as disclosed herein. In some aspects, the systems may include a wind collector of a truncated cone with a first face and a second face, wherein the first face is wider than the second face and is oriented toward an ambient air source; and a body that includes a length, an upper end, and a lower end, wherein the upper end is configured to receive ambient air from the second face of the wind collector and wherein the lower end is open or includes at least one outlet to allow ambient air to escape the system. In some aspects, the sorbent is dispersed along the length of the body.

In some aspects, the body further includes a monolith that includes hollowed polyhedron prisms oriented to allow ambient air to flow therethrough from the upper end to the lower end. In some aspects, the sorbent is coated at least partially on an internal surface or lumen of at least one hollowed polyhedron prism.

In some aspects, the body further includes at least one platform comprised of a fabric, wherein the sorbent is coated at least partially on an exterior surface thereof.

In some aspects, the present disclosure concerns a system for removing CO₂ from ambient air, that includes: a wind collector comprised of a truncated cone with a first face and a second face, wherein the first face is wider than the second face and is oriented toward an ambient air source; a body comprised of a length, an upper end, and a lower end, wherein the upper end is configured to receive ambient air from the second face of the wind collector and wherein the lower end is open or comprises at least one outlet to allow ambient air to escape the system; and a sorbent dispersed along the length of the body. In some aspects, the wind collector is oriented such that the first face is horizontal.

In some aspects, the body further includes a monolith of hollowed polyhedron prisms oriented to allow ambient air to flow therethrough from the upper end to the lower end and wherein the sorbent is coated at least partially on an internal surface or lumen of at least one hollowed polyhedron prism. In some aspects, the monolith can be removed from the body.

In some aspects, the body further includes at least one platform comprised of a fabric, wherein the sorbent is coated at least partially on an exterior surface thereof.

In some aspects, the sorbent of the system includes a silica substrate comprised of silica, a carbonaceous material, and an epoxy modified aminopolymer. In some aspects, the silica is a combination of fumed silica and colloidal silica at a weight ratio of fumed silica to colloidal silica of from 80:20 to 99:1. In some aspects, the carbonaceous material is selected from graphite, graphene, coal, coke, nanotubes, fullerenes, and activated carbon. In some aspects, the carbonaceous material is of 1 to 15 wt % of the sorbent. In some aspects, the epoxy modified aminopolymer comprises 1,2 epoxypentane, 1,2 epoxyhexane, 1,2 epoxypropane (EP) or 1,2 epoxybutane (EB and pentaethylene hexamine (PEHA) or polyethylenimine (PEI). In some aspects, the silica is from 20 to 80 wt % of the sorbent. In some aspects, the epoxy modified aminopolymer is from 20 to 80 wt % of the sorbent. In some aspects, the epoxy modified aminopolymer is PEI, wherein the PEI has a molecular weight from 100 to 2000 daltons. In some aspects, the sorbent has a mean particle size of 10 to 3000 μm. In some aspects, the sorbent includes 1 to 15 wt % graphite and the epoxy-modified aminopolymer is selected from EB-PEI, EB-PEHA, EP-PEI, EP-PEHA, or any combination thereof.

In some aspects, the present disclosure concerns methods for removing CO₂ from ambient air by providing the systems disclosed herein to an ambient air source and positioning the first face of the wind collector to receive wind present in the ambient air.

### BRIEF DESCRIPTION OF THE DRAWINGS

The present invention relates to carbon dioxide (CO₂) capture systems and substrates that are useful therein.

FIG. 1 is a schematic of proposed passive air contactor with sorbent-laden fabric filters. U: linear velocity; L: height; C: clearance; W: width; and G: spacing between fabric filters (FF).

FIGS. 2A-2B are a pair of schematics showing fluid recirculation creates unmixed dead zones after each filter (FIG. 2A); and alternating the filter clearance introduces passive cross flow between fresh air and CO₂ adsorbed air after each fabric filter (FIG. 2B).

FIG. 3 is a graph showing that as the velocity of captured wind increases, the residence time of air in the FF decreases, but the relative amount of air passing through the FF increases.

FIG. 4A is an SEM image of synthesized mesoporous cellular form (MCF) internal.

FIG. 4B is an SEM image of synthesized microsphere.

FIG. 4C is an SEM image of synthesized microsphere internal.

FIG. 5 is a graph showing a 5 cyclic test of 70% 1, 2-epoxybutane (EB) modified polyethylenimine (PEI), EB-PEI/silica sorbent under 400 ppm CO₂ in dry air at 25° C. for adsorption and 100% CO₂ at 110° C. for desorption. Full capacity with 100% CO₂₊₁₀₀% N₂: 2.1 mmol CO₂/g sorbent=0.09 g/g; and working capacity with 100% CO₂: 1.6 mmol/g=0.07 g/g.

FIG. 6A is a graph showing the performance of 70% PEI/silica.

FIG. 6B is a graph showing the performance of 70% EB-PEI/silica sorbents under 400 ppm CO₂ in humid air at 25° C. for adsorption and 100% CO₂ at 110° C. for desorption over 100 cycles. Working capacity: 2.5 mmol/g=0.11 g/g.

FIG. 7 is a pair of images of hybrid carbonaceous infused silica samples with 0, 1, 3, 5, 8 and 10% (wt) carbon content.

FIG. 8A is a microscopic image of hybrid graphite-silica samples with 0% (wt) carbonaceous material.

FIG. 8B is a microscopic image of hybrid graphite-silica samples with 3% (wt) carbonaceous material.

FIG. 8C is a microscopic image of hybrid graphite-silica samples with 5% (wt) carbonaceous material.

FIG. 8D is a microscopic image of hybrid graphite-silica samples with 8% (wt) carbonaceous material.

FIG. 8E is a microscopic image of hybrid graphite-silica samples doped with 50% (wt) EB-PEI onto the hybrid substrate with 5% (wt) carbonaceous material.

FIG. 9A is an SEM image of synthesized hybrid substrate.

FIG. 9B is an SEM image of cross-sectional substrate pores.

FIG. 9C is an SEM image of carbon-embedded substrate surface pores.

FIG. 10 is a graph showing the cyclic test performances of the hybrid substrate with 5% carbon.

FIG. 11 is a graph showing the cyclic test performances of the hybrid substrate with 8% carbon: adsorption with 400 ppm CO₂ at 40° C. and desorption with >99.9% CO₂ at 110° C.

FIG. 12 is a schematic of a passive wind collector design of an embodiment of the present invention.

FIG. 13A shows a further schematic of a passive wind collector design of an embodiment of the present invention that includes the monolith.

FIG. 13B shows a cross-sectional side view of the design shown in FIG. 13A, with the radius R and height H of the wind collector and the length L and width W of the body illustrated.

FIG. 14 shows the effect of monolith wall thickness and pitch on the pressure drop across the monolith. All the parameters used in this simulation are summarized in Table 1.

FIGS. 15A-15C show performance evaluations of cyclic adsorption/desorption for (FIG. 15A) unmodified PEHA vs. 0.05 EP-PEHA/spray-dried silica samples, (FIG. 15B) 0.05 vs. 0.1 EP-PEHA/spray-dried silica samples, and (FIG. 15C) unmodified PEHA vs. PEI 600 (MW)/spray-dried silica samples.

FIGS. 16A-16D show performance evaluations of cyclic adsorption/desorption for (FIG. 16A) unmodified PEI 600 and 0.1 EP-PEI 600/spray-dried silica samples, (FIG. 16B) unmodified PEI, 0.05 EP-PEI, and 0.1 EP-PEI/spray-dried silica samples, (FIG. 16C) unmodified PEI 600/spray-dried silica at 70 and 110° C. during desorption, and (FIG. 16D) unmodified PEI 600 and 0.1 EP-PEI 600/spray-dried silica at 110° C. during desorption.

FIGS. 17A-17B show performance evaluations of cyclic adsorption/desorption for (FIG. 17A) unmodified PEI 600 and 1200/spray-dried silica samples and (FIG. 17B) unmodified PEI, 0.1 EB-PEI, and 0.1 EP-PEI 1200/spray-dried silica samples. 110° C. was used for desorption.

FIG. 18 shows feasibility evaluation of desorption temperatures between 90 and 110° C. at −80 kPa.

FIGS. 19A-19B show average monolith velocity as a function of (FIG. 19A) reactor inlet height and (FIG. 19B) wind catcher inlet height.

FIGS. 20A-20D show the relationship between external wind speed and various factors. FIG. 20A shows the effects of wind speeds on the throughput of passive air contactor with and without the monolith, FIG. 20B shows associated air flow capture % as a function of wind speeds, FIG. 20C shows the effects of wind speeds on monolith velocity as a function of reactor inlet height, and FIG. 20D shows the effects of wind speeds on monolith velocity as a function of wind catcher inlet height.

### DESCRIPTION

The present disclosure concerns novels systems and sorbents for the direct air capture (DAC) of carbon dioxide (CO₂). In some aspects, the present disclosure concerns a DAC system whereby wind can be collected and passed across a sorbent to capture CO₂ therein. In some aspects, the wind passes through a monolith within the system with an exposed sorbent thereon. In some aspects, the present disclosure concerns a sorbent for use within the system described herein or with other CO₂ removal or scrubbing systems. In some aspects, the sorbent can be reused or regenerated for further use within the system by discharging or removing captured CO₂. In some aspects, the sorbent is a silica-carbon composite material doped with a hybrid epoxy aminopolymer, such as 1, 2-epoxybutane (EB) modified polyethylenimine (PEI). It is imperative to passively collect and contain wind to reduce the continuous operating cost (i.e. fan) required to introduce air flow to an adsorption system while providing good mass transfer for subsequent CO₂ capture in the system. Sorbent technology is well suited to DAC, particularly when a passive air contactor system is combined. An ideal sorbent technology requires high CO₂ adsorption capacity, sorbent cost, selectivity towards CO₂ in air, minimal degradation during adsorption and desorption cycles, low energy requirement for desorption, high CO₂ purity recovered from desorption, fast adsorption and desorption kinetics, etc. The present disclosure employs a novel sorbent technology addressing the above technical challenges in an innovative passive air collector system that can effectively capture and fully utilize the wind.

The sorbent technology of the present disclosure has the following significant advantages over other state-of-the-art aminopolymer-based sorbent or other DAC technologies: (1) the entire process from CO₂ capture to separation is simple and does not require high initial capital cost; (2) the sorbent shows minimum degradation by O₂ and thermal desorption over long-term adsorption and desorption cycles; (3) the sorbent can readily achieve >95+% CO₂ purity for CO₂ sequestration or downstream utilization; (4) CO₂ can be separated from the entire sorbent-laden fabric filter (FF) during the desorption phase; (5) the FF can be sequentially replaced from the front; (6) the system can be readily operated in the proposed passive air contactor configuration; and (7) the system does not require water and electrical energy for CO₂ separation in the process.

System

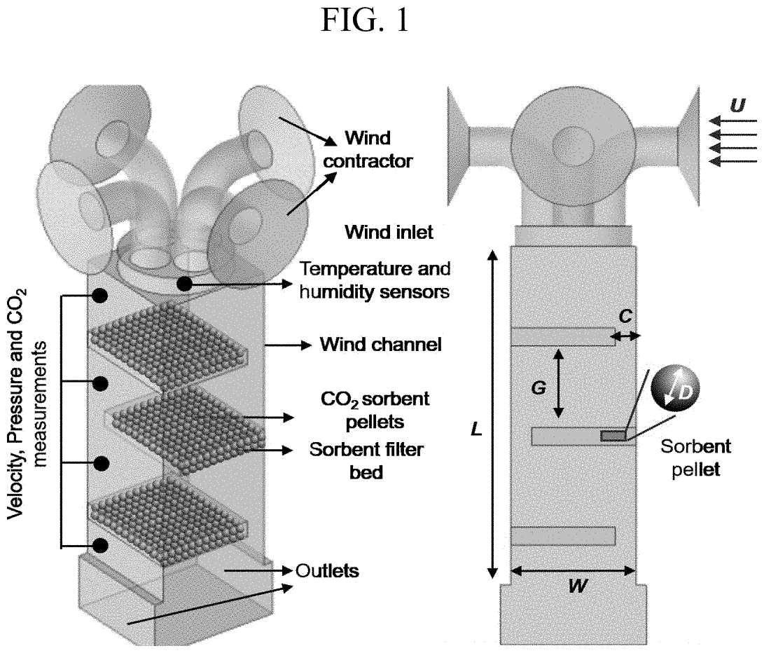

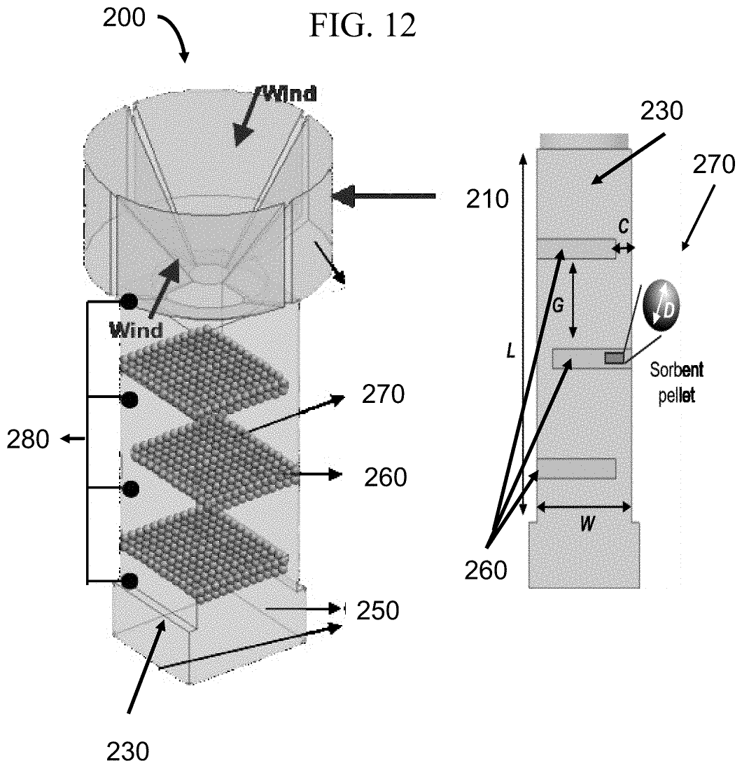

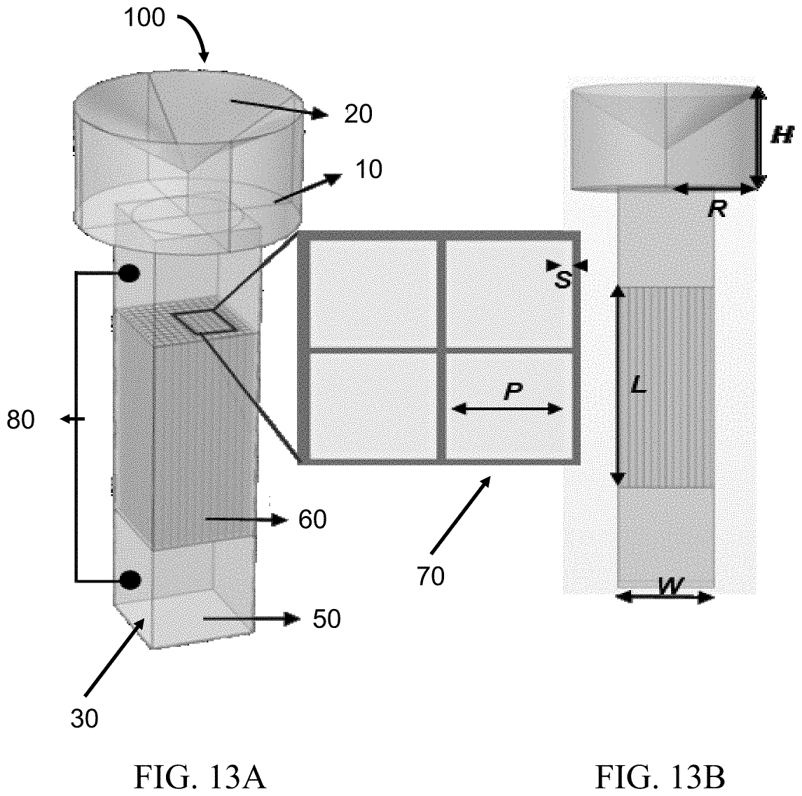

In some aspects, the present disclosure concerns a system for direct air capture (DAC) of carbon dioxide (CO₂) from atmospheric air. In some aspects, the system includes an omni-directional wind collector. In some aspects, the omni-directional wind collector includes one or more funnels or cones or truncated cones that receive atmospheric wind and channel the wind into a body of the system. In some aspects, the funnel includes two openings with connecting walls therebetween, with tapering walls connecting the two. In some aspects, wind is collected at a first opening and flows into the body through a second opening, where the first opening is wider or possesses a greater cross-sectional area than the second opening. In some aspects, the connecting walls between the first and second openings taper toward the second opening. In some aspects, the first opening is perpendicular to the wind flow into the body of the system. In some aspects, the first opening or face is horizontal. In some aspects, the first opening is parallel to the flow of air into the body of the system. In some aspects, the first opening is vertical. FIG. 1 depicts a first opening of the wind collector vertically positioned or parallel to the flow into the body of the system and FIGS. 12 and 13A-B depict the horizontal or perpendicular wider opening. The parallel/vertical first opening directly receives wind, whereas the perpendicular/horizontal arrangement captures wind as it blows across the face of the opening. It will be appreciated that the perpendicular/horizontal alignment allows wind to be captured regardless of the direction of wind flow, whereas the parallel/vertical arrangement may require multiple wind collectors to capture changing wind directions.

In some aspects, the system includes a wind collector, a body, and an outlet, wherein wind enters the system by the wind collector and the wind naturally flows through the body and departs through the outlet. In some aspects, the body is positioned upright and/or perpendicular when positioned on a surface such that wind flows from a wind collected positioned at the top downward through the body. It will be appreciated that for efficient wind flow through the system, the outlet and the wind collector are at opposing ends of the length of the body.

In some aspects, the wind collector and the outlet(s) are at opposing ends of a length of the body of the system. In some aspects, a sorbent material is placed between the wind collector and the outlet(s), such that as wind flows along the length of the body of the system, the wind, or airflow, contacts the sorbent material, allowing the sorbent material to capture at least a portion of the CO₂ therein and effectively reduce the CO₂ concentration of the airflow departing the system.

In some aspects, the body of the system may include sorbent particles. It will be appreciated, however, that loose particles or particles on the walls of the body lack efficiency in achieving high sorbent exposure to the wind. Similarly, packing the body with sorbent may hinder air flow, further frustrating the DAC of CO₂. Accordingly, the present disclosure includes providing the substrate particles within the body on the surface of a substrate therein.

In some aspects, the present disclosure includes a system with a body between a wind collector and one or more outlets, wherein within the body resides a substrate with sorbent particles coated on one or more surfaces thereof. In some aspects, the outlet may include at least one opening toward the base of the body, or the absence of a base altogether. In some aspects, the substrate is a bed or platform extending partially from at least one wall within the body of the system, but does not entirely obscure the entire width of the body such that the wind can flow through the body length. In some aspects, the body may include two or more platforms extending partially across the width of the body at different points along the length thereof. In such aspects, the gaps provided by the incomplete extension across the width of the body are not identical, thereby allowing wind flow to move across one platform as it moves to a gap beneath. Such alternating or “staircased” alignment is also depicted in cross-sectional view in FIGS. 1 and 12. In some aspects, the substrate includes rods that can protrude across the width of the body of the system wherein the surface of the rods is at least partially covered on an outer surface thereof with sorbent particles. In some aspects, the rods are spaced in a pattern along the length and round the perimeter of the body to allow for wind flow while still allowing for contact between sorbent particles and the wind flow to extract CO₂.

In some aspects, the substrate is a monolith within the body of the system, wherein sorbent particles line the exposed surfaces thereof. In some aspects, the monolith may include a series of hollow polyhedron prisms or cells extending along the length of the body of the monolith, such that the wind flow may move through the hollow space as it enters the body of the system from the wind collector and moves toward the outlet(s). In some aspects, sorbent particles are deposited or coated along the internal surfaces within each hollow length along the monolith. As depicted in FIGS. 13A-13B, the monolith can be a series of connected shapes or polyhedrons extending across the width of the body of the system but with hollowed interiors along the respective prism length, such that as wind flows along the length of the body, wind can enter each polyhedron and pass through the hollow interior thereof. Lining the interior walls of each polyhedron along the corresponding length of the body of the system with sorbent particles, allows for wind to contact the sorbent as it moves along the length of the body of the system. It will be appreciated that increasing the number of polyhedrons across the width of the monolith will increase the surface area by which the wind flow contacts sorbent particles along the interior surfaces thereof. It should also be appreciated, though, that increasing polyhedron numbers also reduces the diameter or cross-sectional area or pitch through which wind can flow along the hollow lengths of the polyhedron prisms, which can then restrict wind flow along the length of the body of the system. In some aspects, the monolith is removable from the body, such as through an optional door along the length of the body. Replacement of the monolith allows for regeneration of sorbent particles therein while still allowing the system to functionally remove CO₂ through the insertion of a replacement monolith.

Turning to FIG. 13A, shown is the system 100, that includes a wind collector 10 oriented to collect wind as it passes across the perpendicular wider opening 20. Collected wind flows along the body 30 and out of the outlet(s) 50. The monolith 60 is disposed along the length of the body 30. The monolith 60 is depicted as being composed of connected hollow cuboids 70 (shown in cut out view) that span across the width of the body 60. Lining the inner walls of each hollow cuboid 70 with sorbent particles increases the surface area for contacting airflow and permits more efficient extraction of CO₂ from the airflow as it passes through the system 100. It will be appreciated that the monolith 60 need not be restricted to hollow cuboids 70, but instead other hollow polyhedron prism shapes such as cylinders, hexagonal prisms, pentagonal prisms, heptagonal prisms, octagonal prisms, triangular prisms, and so on, can be utilized wherein the shape is hollow along the length of the prism. Also depicted are optional points of measurement 80 before and after wind passes through the monolith 60 to ensure flow through the system is removing CO₂ and to allow a user to determine when the sorbent particles are spent and/or require regeneration. FIG. 13B shows a cross-sectional view of the system with the appropriate dimensions marked, such as the radius R of the wind collector, the height H of the wind collector, the length L of the body and/or prisms within the monolith and the width of the body/monolith.

In some aspects, the monolith is constructed of a durable material, such as metal, ceramic, polymer, fabric, resin, card material, or the like that can withstand the flow of air without collapsing and provide the necessary structure to remain in place and retain the sorbent material as the wind passes through the hollow prisms therein. In some aspects, it will be appreciated that selecting a rigid material that remains rigid at minimal thickness allows for the establishment of more prism lengths and higher exposed surface area for sorbent contact with the passing air/wind. In some aspects, the wall thickness between the polyhedrons is of from about 50 to about 2000 μm.

In some aspects, the monolith is coated with sorbent particles. The sorbent particles may be the same as those disclosed herein or may be of a different material, such as an amine sorbent, such as a Class I (porous supports impregnated with monomeric or polymeric amines), Class II (amines covalently linked to a solid support), or Class III (porous supports upon which aminopolymers are polymerized in situ) adsorbent. In some aspects, the amines may be primary, secondary, tertiary, or hindered amines. In some aspects, the sorbent is a metal organic framework(s) (MOF), a covalent organic framework(s) (COF), a zeolite, an alumino-silicates, a clay, a porous silica and/or a carbonaceous material(s). In some aspects, the sorbent particles are washcoated onto one or more exposed surfaces within the monolith.

In some aspects, the body of the system provides platforms along the length of the body of the system to provide a surface area for sorbent/wind contact. FIG. 12 shows another version of the system 200 wherein wind enters the wind collector 210 again through flow across a perpendicular opening and into the body 230 and out the outlet(s) 250. Instead of a monolith, the wind passes over platforms 260 that are externally covered with sorbent particles 270 (not to scale) (see also dimensional cut away panel on right). The platforms 260 are not uniformly placed within the body 230 allowing air flow to cross each. Optional points of measurement 280 dispersed above and below the platforms 260 allow a user to determine when the sorbent particles are spent and/or require regeneration. As seen in the right panel of FIG. 12, the platforms 260 are not placed uniformly with regard to their position within the perimeter of the body as the proceed along the length of the body, with the gap C provided between a wall of the body and the end of each platform 260, with further platform 260 spacing of a height G along the length L of the body 230. FIG. 1 shows a similar embodiment, but with the parallel arrangement for the wind collector discussed above. There are four parameters that can impact the pressure drop across the vertical platforms 260: (1) sorbent particle size, (2) sorbent-bed thickness inside the platform, (3) the clearance between the inner wall of the system and the edges of the platform, and (4) the orientation and arrangement of platforms. The air flow through the platforms can be controlled by varying the clearance. Further, the flow through the clearance helps recover the pressure after the air moves beyond the platform which allows for a series of platforms along the length of the body. The pressure recovery can also determine the number of platforms that can be arranged in series without losing air flow through the last platform.

In some aspects, the platform is formed of a fabric material, such that air can pass through as well as around the platform. In other aspects, the platform is formed of a rigid material, such as those discussed with respect to the monolith, such that the platform can remain vertical as the air passes through and exerts a perpendicular or substantially perpendicular force thereon.

In some aspects, the sorb ent can be withdrawn or removed from the body of the system, such as when the sorbent particles are spent and/or cannot extract further CO₂. In some aspects, the platforms or monolith may be removed and replaced with new or regenerated platforms or monolith. In some aspects, the sorbent may be regenerated within the system. In other aspects, it will be appreciated that interchangeable replacement options for the platform or monolith allow for the system to remain in operation and recharge the spent sorbent away from the system. As described herein, the sorbent may be regenerated through elevating the temperature and/or reducing the pressure and/or flowing CO₂ across the sorbent. Such can be achieved within the system, such as by providing a heat and/or gas source, and closing the outlet(s) and the wind collector.

Sorbent

In some aspects, the present disclosure concerns a novel sorbent material for the absorption of CO₂ from the atmosphere or ambient air. In some aspects, the sorbent can be utilized within the system described herein. In other aspects, the sorbent can be deployed within other systems to extract CO₂ therein. The present disclosure also benefits from providing a sorbent that has a long lifespan and can selectively adsorb CO₂ from ambient air with high capacity, leading to significantly reduced CO₂ separation cost. The spent sorbent can be regenerated by desorbing CO₂ using pure CO₂ gas as a stripping gas. This can also greatly benefit various downstream CO₂ utilization technologies that prefer high-purity CO₂ gas. In some aspects, steam or steam with reduced atmospheric pressure can be utilized for temperature-pressure swing desorption. The sorbent and air contactor technology of the present disclosure has the potential to be scalable to handle billion tonne (Gt)-level of CO₂ separation from ambient air.

In some aspects, the sorbent is of a silica-based substrate with enhanced thermal properties. In some aspects, forming a hybrid between a carbonaceous material and a silica allows for increased thermal conductivity. As described herein, temperature is a factor utilized to regenerate the sorbent, and accordingly, improved thermal conductivity assists in the efficiency of regeneration of the sorbent. In some aspects, adding a carbonaceous material of about 1 wt % to about 15 wt % to a mesoporous silica is sufficient to change the thermal conductivity, including about 2, 3, 4, 5, 6, 7, 8, 9, 10, 11, 12, 13, and 14 wt %. Similarly, carbonaceous materials on their own can degrade epoxy aminopolymers, such as EB-PEI, yet in the low concentration as well as with the presence of silica, the degradation is avoided. It will be appreciated that carbonaceous material may include graphite, graphene, coal, coke, nanotubes, fullerenes, activated carbons, and the like. In certain aspects, the carbonaceous material is graphite. As set forth in the examples, a “hybrid” mesoporous silica substrate was synthesized by spray drying a formulation containing graphite powders in order to enhance the heat-transfer property. Unlike many porous carbonaceous materials, the hybrid substrate prevents the degradation of EB-PEI inside the substrate pores.

The sorbent technology of the present disclosure utilizes a hybrid of an organic amine/imine and an epoxylated alkane. In some aspects, the sorbent comprises a 1,2-expoxylated alkane and an aminopolymer or an organic amine/imine. In some aspects, the sorbent is an epoxide-modified aminopolymer. In some aspects, the organic amine or imine includes an amine flanked to at least one alkyl group, which itself may contact a further amine. In some aspects, the organic amine or imine includes multiple amine groups. In some aspects, the organic amine or imine includes at least one chain of at least three amines linked by alkyl groups, such as C₁ to C₈, including C₂, C₃, C₄, C₅, C₆, and C₇. In some aspects, the organic amine or imine may include a polymer of multiple alkyl-linked amines with additional alkyl groups cross-linking the available amines. In some aspects, the organic amine or imine is selected from a triamine, a tetramine, a pentramine, a hexamine, and so on. In some aspects the organic amine or imine is a polyalkyl polyamine or a polymer thereof. In some aspects, the organic amine is pentaethylene hexamine (PEHA) or a polymer thereof. In some aspects, the organic amine or imine is a polymer, such as polyethylenimine (PEI). In some aspects, the polymer has a molecular weight (MW) of about 100 to about 2000 daltons, including about 150, 200, 250, 300, 350, 400, 450, 500, 550, 600, 650, 700, 750, 800, 850, 900, 950, 1000, 1050, 1100, 1150, 1200, 1250, 1300, 1350, 1400, 1450, 1500, 1550, 1600, 1650, 1700, 1750, 1800, 1850, 1900, and 1950 daltons. In some aspects, the epoxylated alkane comprises at least one of 1,2 epoxypropane (EP), 1,2, epoxybutane, (EB), 1,2 epoxypentane, 1,2 epoxyhexane, and so on. In some aspects, the epoxylated alkane is EB and/or

EP.

In some aspects, the epoxide-modified aminopolymer is impregnated into a silica substrate, such as EB-PEI and/or EP-PEHA impregnated onto a silica substrate. In some aspects, the silica substrate is a porous silica. In some aspects, the silica substrate is a combination of fumed silica and colloidal silica. In some aspects, the silica substrate is a hybrid of silica and a carbonaceous material. In some aspects, the hybrid material is of silica and graphite, such as a hybrid of fumed silica, colloidal silica, and graphite. In some aspects, the hybrid material is combined with the epoxy-modified aminopolymer to provide the sorbent. The present sorbent technology utilizes chemical adsorption with numerous advantages of high CO₂ adsorption capacity (up to ˜2.5 mmol CO₂/g sorbent in air at 25° C.), high CO₂ selectivity in air, low sorbent cost (˜83-8 materials cost to manufacture 1 kg sorbent), recovery of >-95+% CO₂ purity due to the use of pure CO₂ as a stripping gas during desorption, fast CO₂ adsorption and desorption kinetics (6 and 18 min for 50% and 90% adsorption, respectively, and 3 min for desorption in pure CO₂), minimum oxidative and thermal degradation during multiple adsorption and desorption cycles over time, and low desorption energy requirements. The sorbent can selectively capture CO₂ over 02, N₂, and H₂O from ambient air.

In some aspects, the silica substrate is formed from a dried slurry of wet milled fumed silica and colloidal silica. In some aspects, the slurry is prepared at about 20:1 to about 1:1 fumed silica to colloidal silica, including about 95:5, 19:1, 18:1, 17:1, 16:1, 15:1, 14:1, 13:1, 12:1, 11:1, 10:1, 9:1, 8:1, 7:1, 6:1, 5:1, 4:1, 3:1, and 2:1. For examples, as set forth in the examples 133 g of fumed silica can be combined with 17.5 g colloidal silica. The slurry can then be dried, such as through spray drying. In some aspects, carbonaceous material can be included in the wet milling, wherein the carbonaceous material is of about 1 wt % to about 15 wt % of the components in the slurry or the dry weight thereof. In some aspects, the dried silica substrate is then doped with the epoxide-modified aminopolymers. In some aspects the doping is performed at a ratio of about 10:1 to about 1:10 with respect to the silica substrate, including about 9:1, 9:1, 7:1, 6:1, 5:1, 4:1, 3:1, 2:1, 1:1, 1:2, 1:3, 1:4, 1:5, 1:6, 1:7, 1:8, and 1:9. For example, as set forth in the examples herein, the EB-PEI was doped in the carbonaceous silica substrate at about 50%:50%.

In some aspects, the silica substrates as described herein have a spherical or near-spherical shape. In some aspects, the silica substrates as described herein have an average diameter or cross-sectional width of from about 10 μm to about 300 μm, including about 20, 30, 40, 50, 60, 70, 80, 90, 100, 110, 120, 130, 140, 150, 160, 170, 180, 190, 200, 210, 220, 230, 240, 250, 260, 270, 280, and 290 μm.

In some aspects, the sorbent of the present disclosure is capable of regeneration. As an example, when amine-based sorbent and CO₂ react, urea is reported to be responsible for degradation as a result of a multi-chain reaction between the primary amine in branched PEI and CO₂. Unlike a conventional PEI-based sorbent, the EB-PEI sorbent utilizes the functionalization of EB to the primary amines, which result in lowering the basicity and increasing the steric hindrance of the amine center. This EB functionalization to PEI can significantly suppress the urea formation, oxidative amine degradation, and heat of CO₂ adsorption. These benefits allow for CO₂ desorption using pure CO₂ at elevated temperature of about 70 to about 200° C., including about 80, 90, 100, 110, 120, 130, 140, 150, 160, 170, 180, and 190° C. In some aspects, the CO₂ to regenerate the sorbent is of about 95% purity or higher, including about 96, 97, 98, 99, and 99.9% purity. This is an important breakthrough for the DAC application of the aminopolymer-based sorbent technology. In some aspects, the sorbent is regenerated at a pressure below atmospheric pressure, such as from about 0.9 to about 0.01 atm, including about 0.8, 0.75, 0.7, 0.65, 0.6, 0.55, 0.5, 0.45, 0.4, 0.35, 0.3, 0.25, 0.2, 0.15, 0.1, 0.05, 0.04, 0.03, and 0.02 atm. In some aspects steam or steam and low atmospheric pressure can be applied to regenerate the sorbent.

Aspects

A 1^{st} aspect, either alone or in combination with any other aspect herein concerns a sorbent for carbon dioxide removal from ambient air comprising silica, a carbonaceous material, and an epoxy modified aminopolymer.

A 2^{nd} aspect, either alone or in combination with any other aspect herein concerns the sorbent of the 1^{st} aspect, wherein the silica is a combination of fumed silica and colloidal silica.

A 3^{rd} aspect, either alone or in combination with any other aspect herein concerns the sorbent of the 2^{nd} aspect, wherein the weight ratio of fumed silica to colloidal silica is of from 80:20 to 99:1.

A 4^{th} aspect, either alone or in combination with any other aspect herein concerns the sorbent of the 2^{nd} aspect, wherein the weight ratio of fumed silica to colloidal silica is 95:5.

A 5^{th} aspect, either alone or in combination with any other aspect herein concerns the sorbent of the 1^{st} aspect, wherein the carbonaceous material is selected from the group consisting of graphite, graphene, coal, coke, nanotubes, fullerenes, and activated carbon.

A 6^{th} aspect, either alone or in combination with any other aspect herein concerns the sorbent of the 1^{st} aspect, wherein the carbonaceous material is from 1 to 15 wt % of the sorbent.

A 7^{th} aspect, either alone or in combination with any other aspect herein concerns the sorbent of the 1^{st} aspect, wherein the epoxy modified aminopolymer comprises an epoxy moiety selected from 1,2 epoxypentane, 1,2 epoxyhexane, 1,2 epoxypropane (EP) or 1,2 epoxybutane (EB) and an aminopolymer selected from pentaethylene hexamine (PEHA) or polyethylenimine (PEI).

An 8^{th} aspect, either alone or in combination with any other aspect herein concerns the sorbent of the 1^{st} aspect, wherein the silica is from 20 to 80 wt % of the sorbent.

A 9^{th} aspect, either alone or in combination with any other aspect herein concerns the sorbent of the 1^{st} aspect, wherein the epoxy modified aminopolymer is from 20 to 80 wt % of the sorbent.

A 10^{th} aspect, either alone or in combination with any other aspect herein concerns the sorbent of the 1^{st} aspect, wherein the epoxy modified aminopolymer is PEI, wherein the PEI has a molecular weight of from 100 to 2000 daltons.

An 11^{th} aspect, either alone or in combination with any other aspect herein concerns the sorbent of the 1^{st} aspect, wherein the sorbent has a mean particle size from 10 to 300 μm.

A 12^{th} aspect, either alone or in combination with any other aspect herein concerns the sorbent of the 1^{st} aspect, further comprising 1 to 15 wt % graphite and wherein the epoxy-modified aminopolymer is selected from EB-PEI, EB-PEHA, EP-PEI, EP-PEHA, or any combination thereof.

A 13^{th} aspect, either alone or in combination with any other aspect herein concerns a method for removing CO₂ from ambient air comprising providing a flow of ambient air across the sorbent of the 1^{st} aspect.

A 14^{th} aspect, either alone or in combination with any other aspect herein a method for regenerating the sorbent of the 1^{st} aspect, comprising heating the sorbent to above 70° C. at below 0.9 atm and flowing CO₂ or steam across the sorbent.

A 15^{th} aspect, either alone or in combination with any other aspect herein concerns system for removing CO₂ from ambient air, comprising the sorbent of the 1^{st} aspect.

A 16^{th} aspect, either alone or in combination with any other aspect herein concerns the system of the 15^{th} aspect, further comprising a wind collector comprised of a truncated cone with a first face and a second face, wherein the first face is wider than the second face and is oriented toward an ambient air source; and a body comprised of a length, an upper end, and a lower end, wherein the upper end is configured to receive ambient air from the second face of the wind collector and wherein the lower end is open or comprises at least one outlet to allow ambient air to escape the system; wherein the sorbent is dispersed along the length of the body.

A 17^{th} aspect, either alone or in combination with any other aspect herein concerns the system of the 16^{th} aspect, wherein the body further comprises a monolith comprised of hollowed polyhedron prisms oriented to allow ambient air to flow therethrough from the upper end to the lower end and wherein the sorbent is coated at least partially on an internal surface of at least one hollowed polyhedron prism.

An 18^{th} aspect, either alone or in combination with any other aspect herein concerns the system of the 16^{th} aspect, wherein the body further comprises at least one platform comprised of a fabric, wherein the sorbent is coated at least partially on an exterior surface thereof.

A 19^{th} aspect, either alone or in combination with any other aspect herein concerns a system for removing CO₂ from ambient air, comprising:

a wind collector comprised of a truncated cone with a first face and a second face, wherein the first face is wider than the second face and is oriented toward an ambient air source; and
a body comprised of a length, an upper end, and a lower end, wherein the upper end is configured to receive ambient air from the second face of the wind collector and wherein the lower end is open or comprises at least one outlet to allow ambient air to escape the system; and a sorbent dispersed along the length of the body.

A 20^{th} aspect, either alone or in combination with any other aspect herein concerns the system of the 19^{th} aspect, wherein the body further comprises a monolith comprised of hollowed polyhedron prisms oriented to allow ambient air to flow therethrough from the upper end to the lower end and wherein the sorbent is coated at least partially on an internal surface of at least one hollowed polyhedron prism.

A 21^{st} aspect, either alone or in combination with any other aspect herein concerns the system of the 19^{th} aspect, wherein the monolith can be removed from the body.

A 22^{nd} aspect, either alone or in combination with any other aspect herein concerns the system of the 19^{th} aspect, wherein the body further comprises at least one platform comprised of a fabric, wherein the sorbent is coated at least partially on an exterior surface thereof.

A 23^{rd} aspect, either alone or in combination with any other aspect herein concerns the system of the 19^{th} aspect, wherein the sorbent comprises a silica substrate comprised of silica, a carbonaceous material, and an epoxy modified aminopolymer.

A 24^{th} aspect, either alone or in combination with any other aspect herein concerns the system of the 23^{rd} aspect, wherein the silica is a combination of fumed silica and colloidal silica at a weight ratio of fumed silica to colloidal silica of from 80:20 to 99:1.

A 25^{th} aspect, either alone or in combination with any other aspect herein concerns the system of the 24^{th} aspect, wherein the carbonaceous material is selected from the group consisting of graphite, graphene, coal, coke, nanotubes, fullerenes, and activated carbon.

A 26^{th} aspect, either alone or in combination with any other aspect herein concerns the system of the 24^{th} aspect, wherein the carbonaceous material is from 1 to 15 wt % of the sorbent.

A 27^{th} aspect, either alone or in combination with any other aspect herein concerns the system of the 23^{rd} aspect, wherein the epoxy modified aminopolymer comprises 1,2 epoxypentane, 1,2 epoxyhexane, 1,2 epoxypropane (EP) or 1,2 epoxybutane (EB) and pentaethylene hexamine (PEHA) or polyethylenimine (PEI).

A 28^{th} aspect, either alone or in combination with any other aspect herein concerns the system of the 23^{rd} aspect, wherein the silica is from 20 to 80 wt % of the sorbent.

A 29^{th} aspect, either alone or in combination with any other aspect herein concerns the system of the 23^{rd} aspect, wherein the epoxy modified aminopolymer is from 20 to 80 wt % of the sorbent.

A 30^{th} aspect, either alone or in combination with any other aspect herein concerns the system of the 23^{rd} aspect, wherein the epoxy modified aminopolymer is PEI, wherein the PEI has a molecular weight of from 100 to 2000 daltons.

A 31^{st} aspect, either alone or in combination with any other aspect herein concerns the system of the 23^{rd} aspect, wherein the sorbent has a mean particle size from 10 to 3000 μml.

A 32^{nd} aspect, either alone or in combination with any other aspect herein concerns the system of the 23^{rd} aspect, further comprising from 1 to 15 wt % graphite and wherein the epoxy-modified aminopolymer is selected from EB-PEI, EB-PEHA, EP-PEI, EP-PEHA, or any combination thereof.

A 33^{rd} aspect, either alone or in combination with any other aspect herein concerns the system of the 19^{th} aspect, wherein the wind collector is oriented such that the first face is horizontal.

34. A method for removing CO₂ from ambient air comprising providing the system of claim 19 to an ambient air source and positioning the first face of the wind collector to receive wind present in the ambient air.

### EXAMPLES

### Sorbent Production

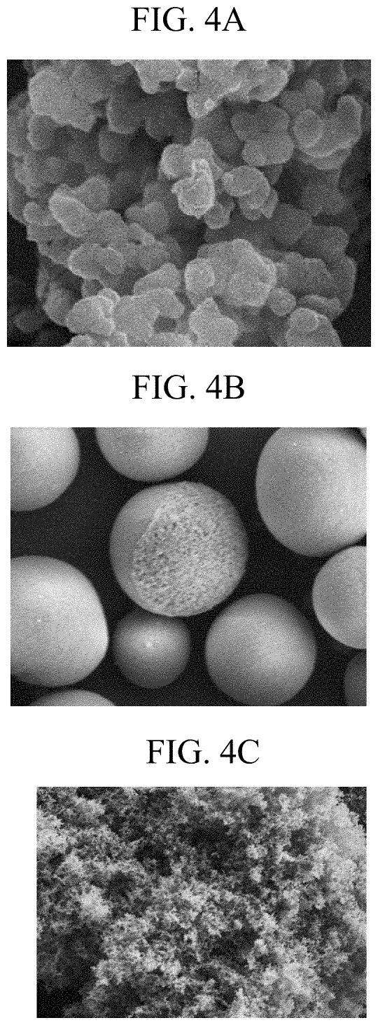

To prepare one embodiment of the sorbent of the present invention, two siliceous substrates of mesoporous cellular form (MCF) and microsphere silica substrates were synthesized and used to impregnate EB-PEI for 70% (wt) EB-PEI/silica sorbent. The synthesized MCF showed high pore volume (˜2.8 cm3/g), surface area (˜520-580 m2/g), cell pore diameter (˜23 nm), and an average particle size of ˜40 μm. The microsphere silica substrate was also synthesized using a lab-scale spray dyer, which gave the particle sizes of ˜10-200 μm, pore volume (˜1.4 cm3/g), pore diameter (˜20 nm), and surface area (˜300 m2/g). The microsphere silica substrates gave slightly better or similar performances with a 70% (wt) EB-PEI loading. The 70% loading was found to be an optimum loading for both substrates. The morphology of the mesopores of the synthesized substrates was confirmed by SEM as shown in FIG. 4.

When amine-based sorbent and CO₂ react, urea is reported to be responsible for degradation as a result of a multi-chain reaction between the primary amine in branched PEI and CO₂. Unlike a conventional PEI-based sorbent, the EB-PEI sorbent utilizes the functionalization of EB to the primary amines, which result in lowering the basicity and increasing the steric hindrance of the amine center. This EB functionalization to PEI can significantly suppress the urea formation, oxidative amine degradation, and heat of CO₂ adsorption. These benefits allowed for CO₂ desorption using pure CO₂ at 110° C., which was determined to be optimum between 90-120° C. This is a very important breakthrough for the DAC application of the aminopolymer-based sorbent technology. An optimal ratio of EB to branched PEI (Mn=˜600) was determined and used for the synthesis of the 70% (wt) EB-PEI/silica sorbent, which was also confirmed by 1H NMR (data not shown).

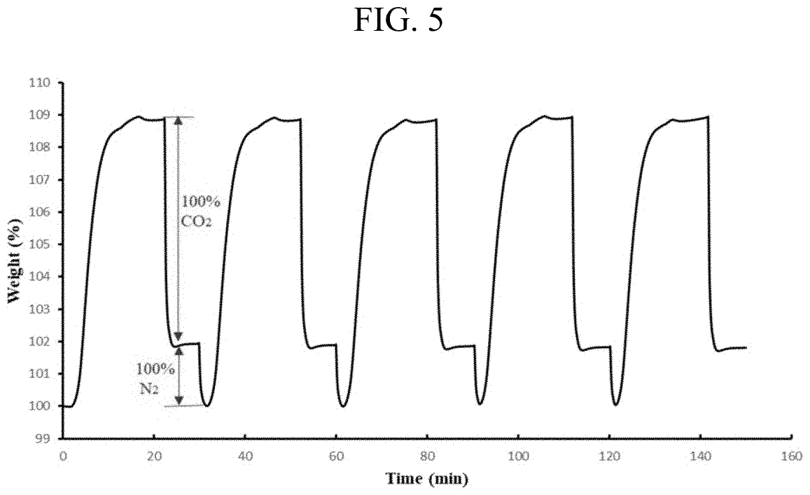

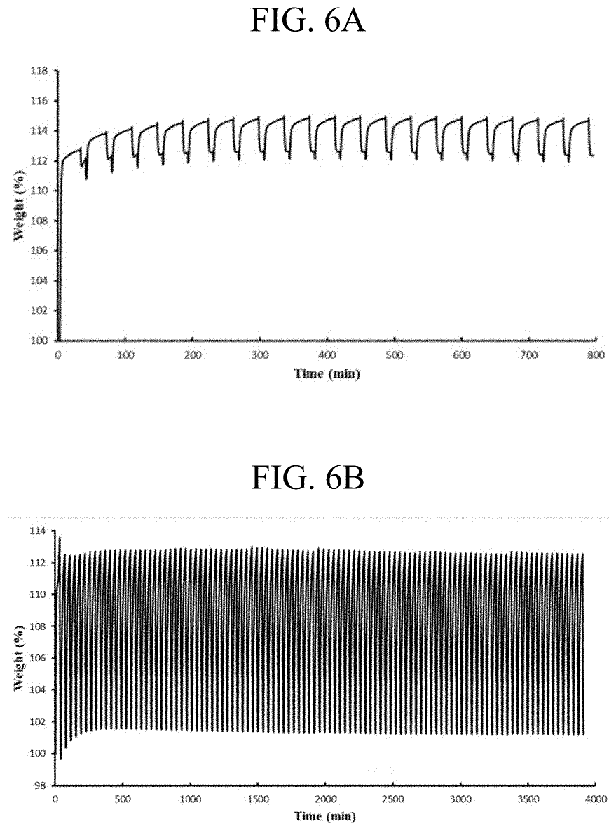

The performance of the sorbent was obtained by running a cyclic test in TGA using 400 ppm CO₂ in dry air at 25° C. for adsorption and 100% CO₂ at 110° C. for desorption (FIG. 5). The performance was consistent, and both adsorption and desorption cycle times were short (i.e. fast kinetics, Table 1). CO₂ could be released from ˜109 to ˜102% in 3 min using 100% CO₂, but the rest of ˜2% CO₂ could not be released due to thermal equilibrium at 110° C. The rest of 2% CO₂ accounting for ˜22% of the full capacity could be released using pure N₂ in 2 min. This indicates that ˜78% of the full capacity can be recovered with a high CO₂ purity using pure CO₂ and the remaining sorbent capacity can be fully recovered by evacuating CO₂ in the desorber with N₂ gas (if needed). To examine the reproducibility of the performance, a 100 cyclic test was performed under dry (data not shown) and humid air (FIG. 6B) conditions. In contrast, PEI/silica sorbent could not be regenerated under the conditions (FIG. 6A). The 100 cyclic performance under a dry air condition was close to that shown in FIG. 5. An acidified bubbler at pH ˜4 at 20° C. was used to generate ˜2.3% H₂O vapor. Under the humid air condition, the capacity was increased to ˜2.5 mmol CO₂/g sorbent (=0.11 g/g). An increase in the working capacity from 1.6 to 2.5 mmol/g seems to be a combination of the adsorption of H₂O vapor and the dual formation of bicarbonate and carbonate with water that can capture more CO₂. A sequential set-up of TGA followed by MS confirmed the desorption of CO₂ (major peak) and H₂O (minor peak, data not shown). Overall, the sorbent showed a very stable and consistent performance over 100 cycles under practical test conditions and did not show a significant sign of degradation. The sorbent was also evaluated at 45° C. under the same conditions over 100 cycles, and showed ˜1.8 mmol CO₂/g sorbent (=0.08 g/g, data not shown). In summary, the sorbent showed a consistent performance of ˜1.8-2.5 mmol CO₂/g sorbent over 100 cycles.

### Carbonaceous Sorbent

To make the carbonaceous sorbent substrates, different ratios of fumed silica, colloidal sol, and carbonaceous materials were wet milled for subsequent spray drying to form fine mesoporous substrates. Then the spray-dried substrates were calcined under air in terms of different space velocity, final temperature, ramp rate, and calcination time. A detailed synthesis procedure is given below.

133 g of fumed silica, 17.5 g of colloidal silica sol and pre-determined amounts between 4-11 g of graphite powder (size: <20 μm) were mixed in water to make a 1 kg slurry. The ratio of fumed silica to colloidal silica was fixed at 95:5% (wt), the ratio of graphite to the total silica content was controlled between 3-8% (wt), and the total silica content in the slurry mixture was fixed at 14% (wt). The slurry was mixed using wet milling for ˜12 hours until the viscosity reached ˜4,500-5,000 cP.

Then, the slurry was dried using a spray dryer. The slurry feed rate was ˜40 m1/min and the atomizer pressure for centrifugation was ˜1-3 kg/cm3. The inlet temperature of the spray dryer was set to 210° C. and the outlet temperature was kept above 105° C. The spray-dried particles were then calcined in air in a tubular furnace. The calcination temperature was controlled between 500 and 800° C. with a ramp rate of 5° C./min.

Some of the silica substrate samples with and without graphite powders were analyzed for surface area and pore size analyses. Most samples had the surface areas of ˜340-370 m2/g, the pore volume of ˜1.5 cm3/g, and the average pore sizes of ˜17-20 nm. The particle sizes were controllable between ˜10-150 μm during spray drying.

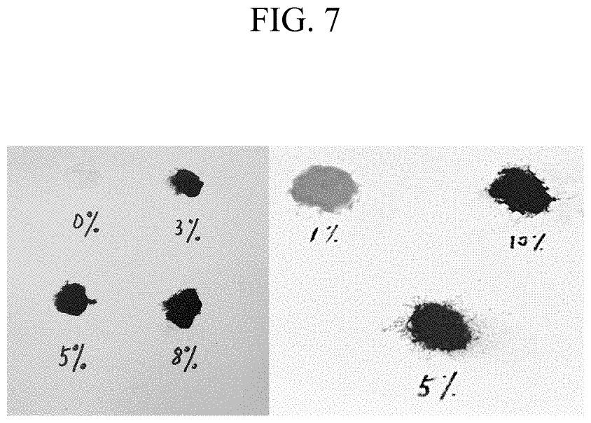

FIG. 7 shows pictures of the hybrid substrates with different carbon content after spray drying. The dark contrast increased with an increase in graphite content.

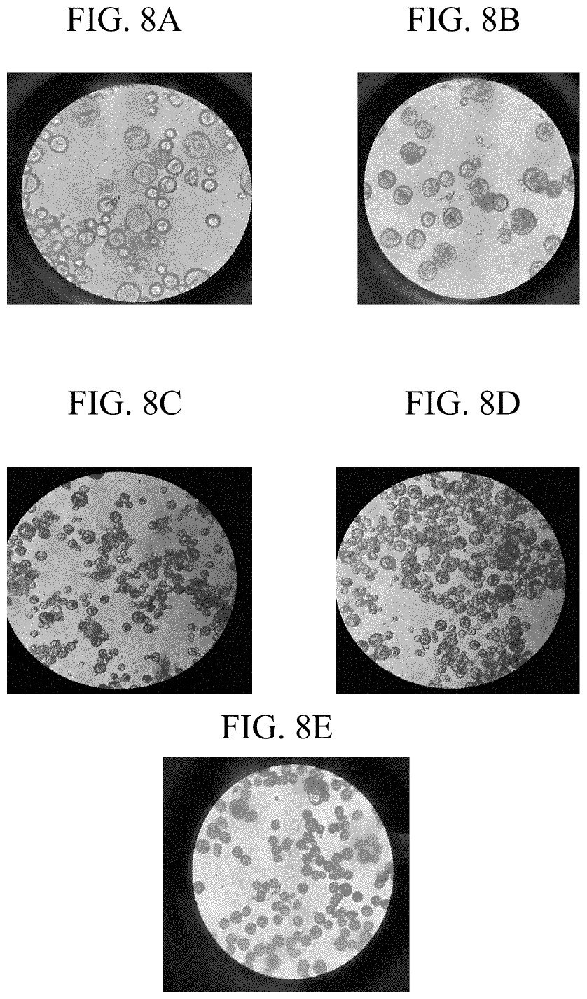

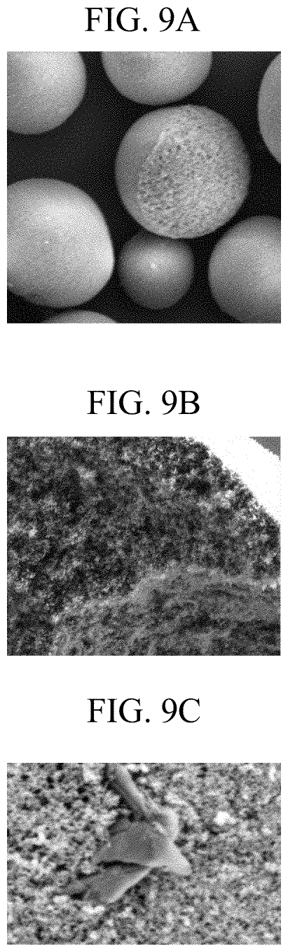

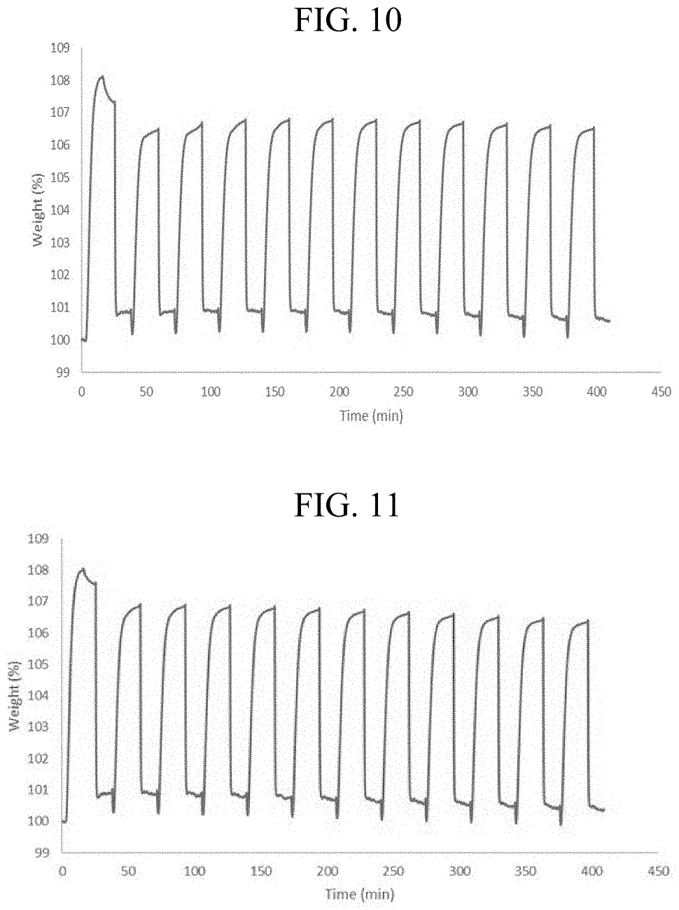

The microscopic images of spray-dried substrate particles are shown in FIGS. 8A-E. The black spots are the carbon particles embedded into the silica substrate. The morphology of the mesopores of the hybrid substrate was also confirmed by SEM as shown in FIGS. 9A-C. When the same 50% (wt) EB-PEI was doped onto the silica substrates with 5% and 8% carbon, the reproducible performance test results shown in FIGS. 10 and 11 were obtained.

It was then attempted to optimize the formulation in terms of the degree of the modification, the type of aminopolymer, and substrate. Several different epoxide-modified aminopolymers were evaluated to determine the best formulation demonstrating stable cyclic performances with high CO₂ capacities.

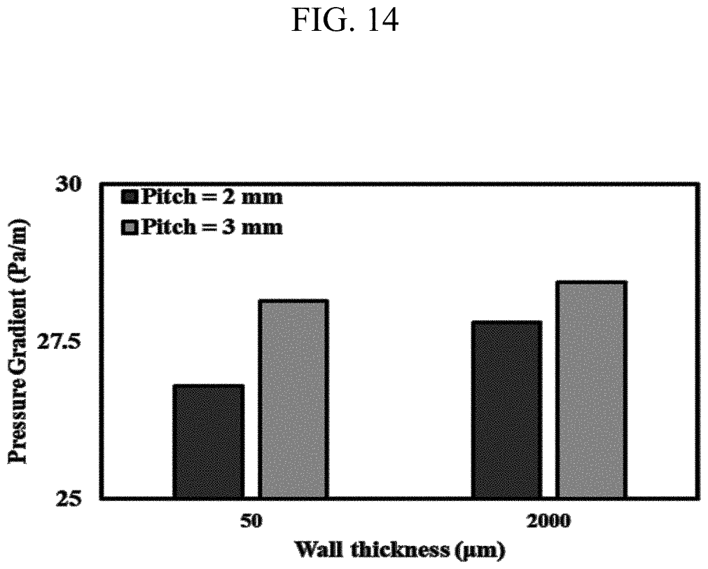

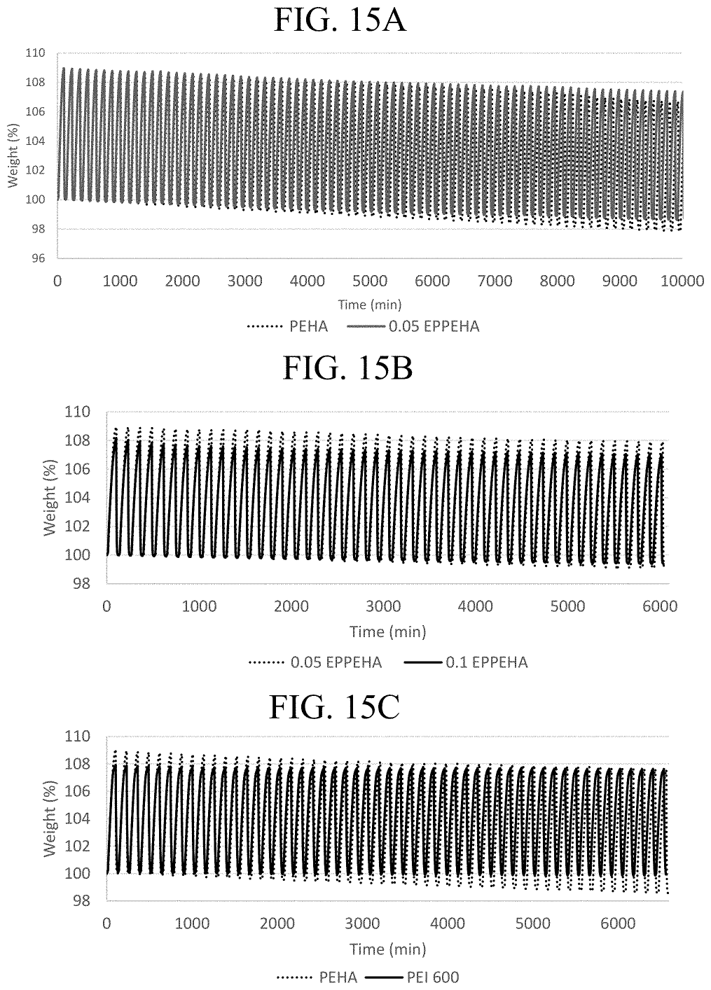

In continuation with our previous evaluations, we evaluated 1, 2-epoxypropane (EP, MW=58)-modified pentaethylenehexamine (PEHA, Mn=232, EP-PEHA) impregnated onto spray-dried silica substrate. Epoxide modification increased the stability of the sorbent with an increase in the degree of the modification (FIG. 15A) but decreased CO₂ adsorption capacities (FIG. 15B). However, PEHA is a small polyamine than polyethylenimine (PEI, Mn=−600) and thus less stable than PEI over a 50 cyclic test (FIG. 14C). PEHA showed ˜2% higher CO₂ capacity than PEI but seems to lose the capacity benefits over the cycles.

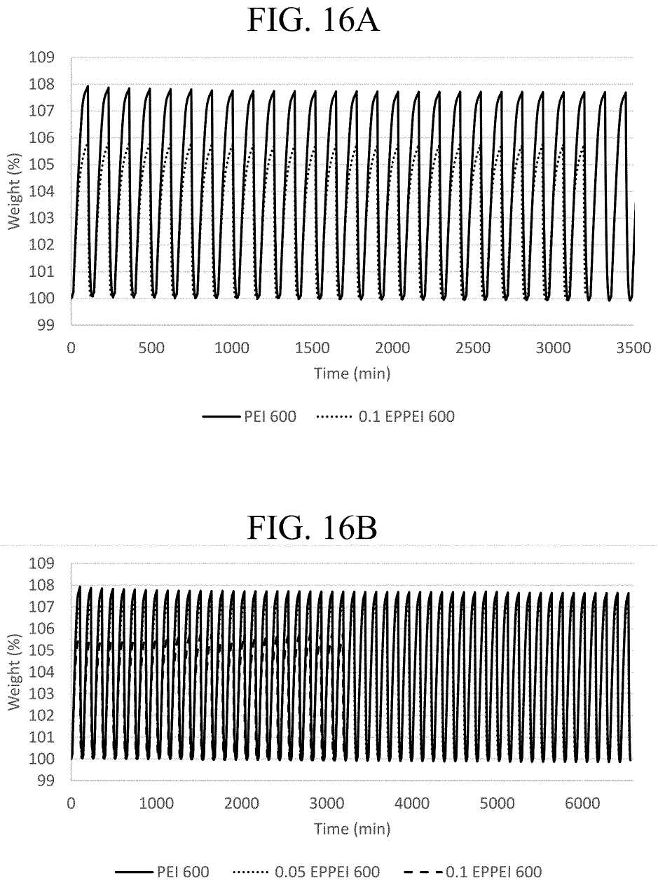

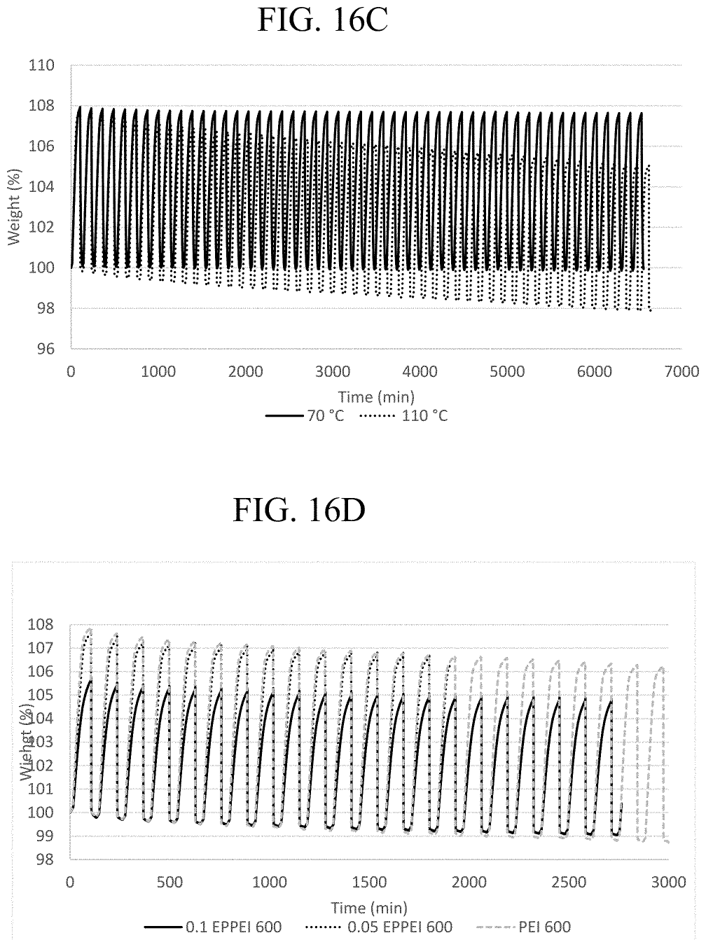

Then, the performance evaluations were conducted for unmodified and EP-modified PEI 600/spray-dried silica samples. EP modification decreased CO₂ adsorption capacities but helped improve the stability of the sorbent with an increase in the degree of the modification (FIGS. 16A and 16B). Between 70 and 110° C., the unmodified PEI 600/spray-dried silica sorbent was thermally more stable at 70° C. during desorption (FIG. 16C). The degree of EP modification on PEI 600 between 0.05 and 0.1 EP-PEI 600 did not show a significant difference in thermal stability over relatively short 20 cycles (FIG. 16D).

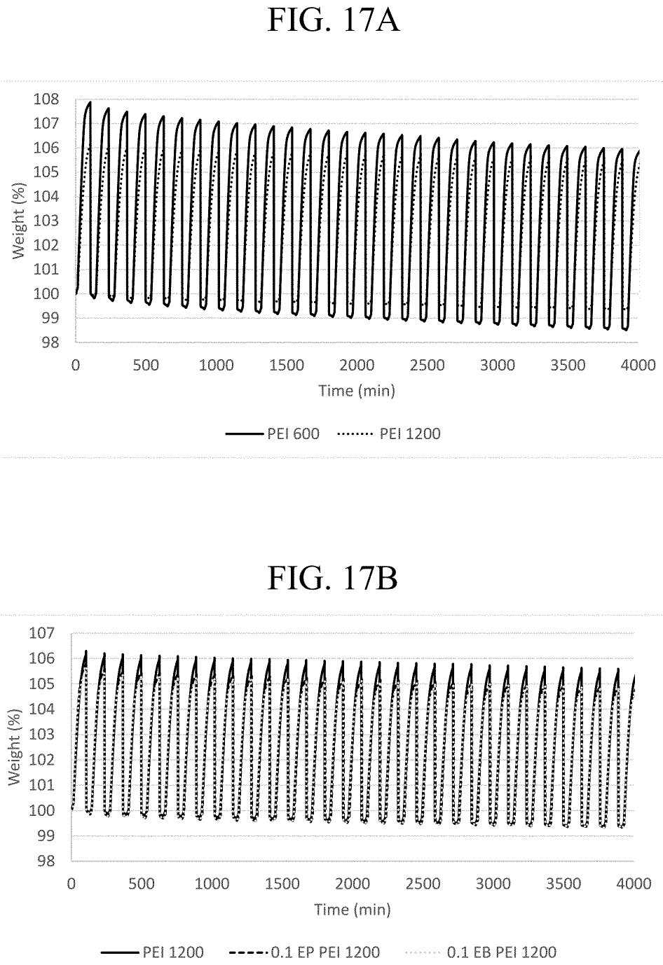

Then, unmodified PEI 600 and 1200 (Mn) were compared for CO₂ adsorption capacity and thermal stability (FIGS. 17A and 17B). In the beginning of the cycles, unmodified 600 showed ˜2% (wt) higher CO₂ adsorption capacities but gradually decreasing capacities due to low thermal stability over 30 cycles (FIG. 17A). When 0.1 EB and EP modifications were compared, no significant difference was observed in the performance and stability over 30 cycles (FIG. 16(b)). However, EP and EB modifications need to be evaluated for the adsorption of water vapor and thus desorption energy requirement.

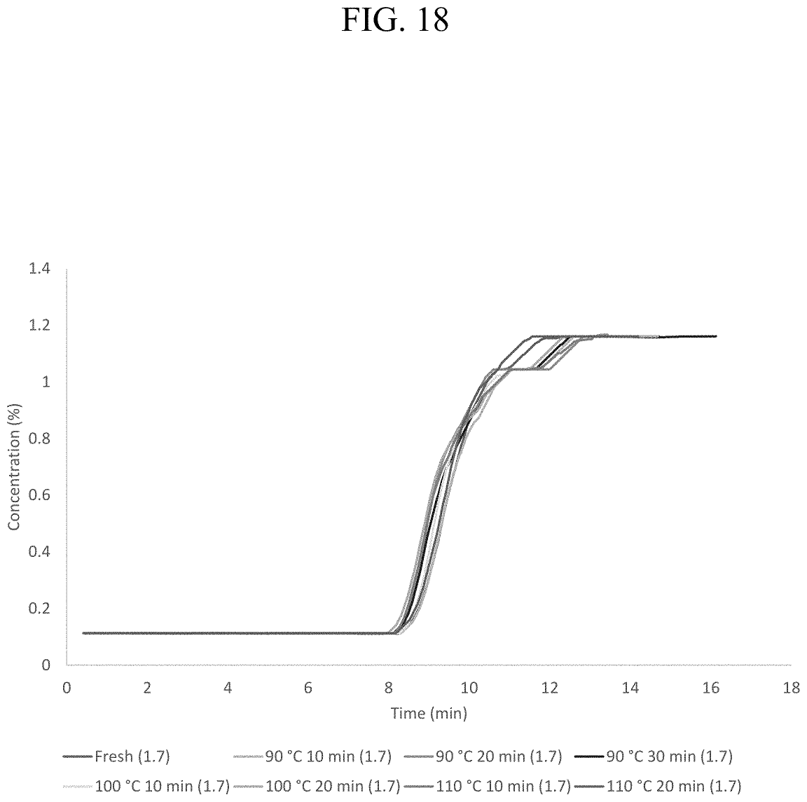

Although the thermal stability of the sorbent can be evaluated at a certain desorption temperature using N₂ gas as a sweep gas during desorption, it is not a practical desorption condition. Therefore, 0.1 EP-PEI 1200/spray-dried silica sorbent was evaluated for a feasibility of using a combination of temperature and pressure in a fixed-bed reactor (FIG. 17A). The sorbent capacities were evaluated at 90, 100, and 110° C. and −80 kPa for 10, 20, and 30 min. Although optimal desorption temperature and pressure operating conditions need to be determined, the CO₂ adsorption capacities determined under the various temperature and pressure conditions were very close, suggesting that any temperature between 90-110° C. can be used to recover its working capacity for desorption along with −80 kPa for at least 10 min. FIG. 18 presents the results obtained graphically.

### Platformed Body System

The ability of wind to flow through a platformed sorbent body as described herein was assessed in a system that passively collects air from all directions and drives it through the rectangular duct containing a series of sorbent laden fabric filters (FF). CO₂ is adsorbed as air passes through each fabric filter layer (FIG. 1). As there are no moving parts to the wind catchers, their maintenance is very low. The overall efficiency of CO₂ adsorption in this system is the coupled interplay between the (i) air velocity and pressure distribution through and around the FFs and (ii) kinetics and mass transfer characteristics of CO₂ adsorption within the FF. To resolve this complex interplay, a 3D computational fluid dynamics (CFD) model was developed to analyze the effect geometric parameters of the air contactor and FFs on the transport of air through and around the air filters. Then, the effect of sorbent pellet size on mass transfer and adsorption characteristics of CO₂ within the fabric filters is analyzed. These parameters are listed in Table 1.

TABLE 1
Air contactor parameter range

| Parameter | Proposed range | Prelim. results |
|---|---|---|
| Wind velocity, U (m/s) | 0-12 | 4 |
| Channel length, L (m) | 1-5 | 2 |
| Channel width, W (m) | 0.1-1 | 0.6 |
| Fabric filter thickness, t (m) | 0-0.5 | 0.3 |
| Fabric filter clearance, C (m) | 0-0.3 | 0.05 |
| Inter fabric filter gap, G (m) | 0-1 | 0.5 |
| Sorbent pellet dia., D (μm) | 50-500 | 100, 200 |
| Sorbent filter porosity, p | 0.2-0.5 | 0.35 |

Effect of fabric filter geometry: A model simulation reveals that without any clearance between the fabric filter and channel wall, the pressure drop across each fabric filter is large requiring a larger wind velocity to drive the same amount of air through the system. However, with the addition of a small clearance (C=5 cm), pressure can be recovered after the FF section, enabling operation with up to three FFs in a single channel with high enough pressure (˜500 Pa) at the last fabric filter to still drive the air through the porous section. Increasing the clearance increases the pressure recovered across the fabric filters at the cost of less air passing through these fabric filters. The effect of fabric filter thickness on the resulting velocity and pressure profile can also be evaluated. While increasing the fabric filter thickness does increase the residence time of air within the fabric filter, the increased permeability due to the increased filter thickness decreases the amount of air passing through them.

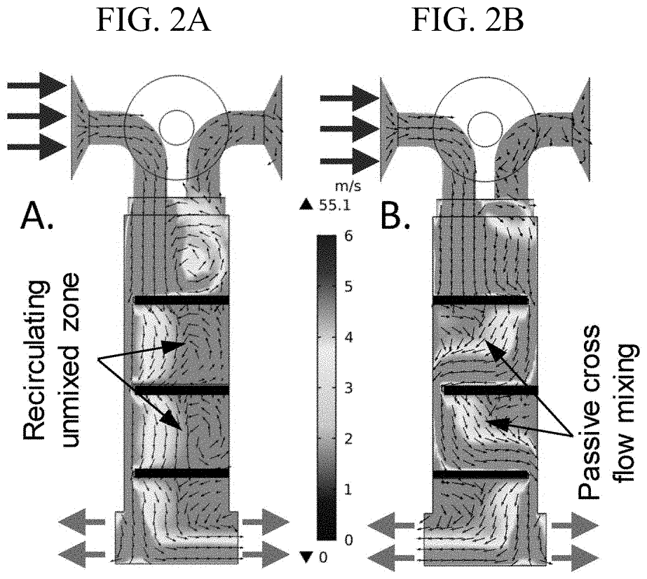

Effect of fabric filter orientation and location on the air mixing: When combining multiple fabric filters in series, it is important to consider the orientation and location of the filters to maximize the flux of CO₂ rich air through the FF. This model reveals that orienting the FF in an inline mixer pattern (with alternating FF clearance zones) greatly enhances the ability of the channel to mix the CO₂ rich air (air passing through the clearance zone) with CO₂ removed air (air passing through the FF) after each FF section (FIGS. 2A, 2B). This 3D circulating vortex induced passive mixing is a feature of channel geometry without the need of any active mixing elements.

Effect of changing the internal sorbent pellet parameter: Our flow simulations also suggests that for an average wind speed of 4 m/s, changing the sorbent pellet diameter of FF in the range of 100 to 500 μm does not significantly affect the flux of air through the FF. Above the pellet size of 500 μm, FF permeability increases, thus resulting in more air flux through them. But, this increased flux comes at the cost of higher intraparticle diffusional resistance within the FF due to large pellet sizes.

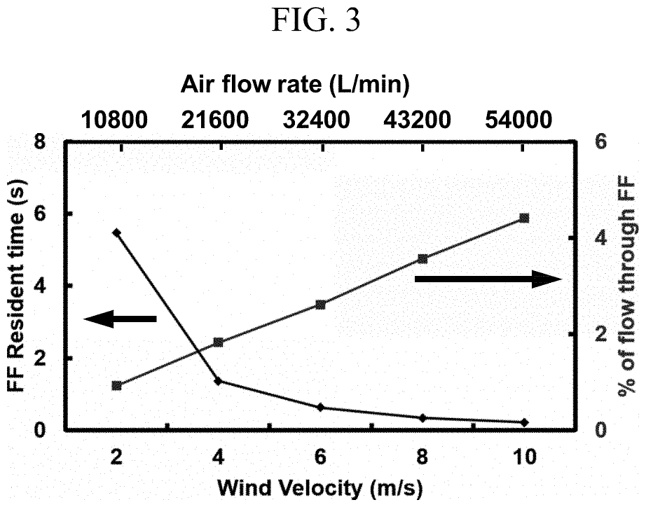

Estimating the throughput: To ensure that our passive flow method is capable of passing sufficient ambient air through the fabric filter, the air flow flux through the fabric filter was calculated with respect to total air flow flux into the air contactor. It was found that for an average wind speed of 4 m/s, the air contactor can capture air at 0.3 m3/s or 18,350 L/min. A FF in the channel with a thickness of 3 cm, sorbent pellet size of 200 μm and a clearance of 5 cm creates a pressure drop that is large enough to drive 0.011 m3/s or 574 L/min of air through it, with an average air velocity in the FF of 0.029 m/s. As the wind velocity increases, the relative amount of air flow passing through FF increases (in comparison the air passing through the clearance) but the residence time of air in the FF decreases (FIG. 3). It was found that for the initial geometric parameters, a sweet spot exists around the average wind velocity of 4 m/s where percentage of air flow through the FF is 1-3% of total captured air and the residence time of air is 1-4 seconds, which is long enough for CO₂ molecules to undergo adsorption on the sorbent pellets.

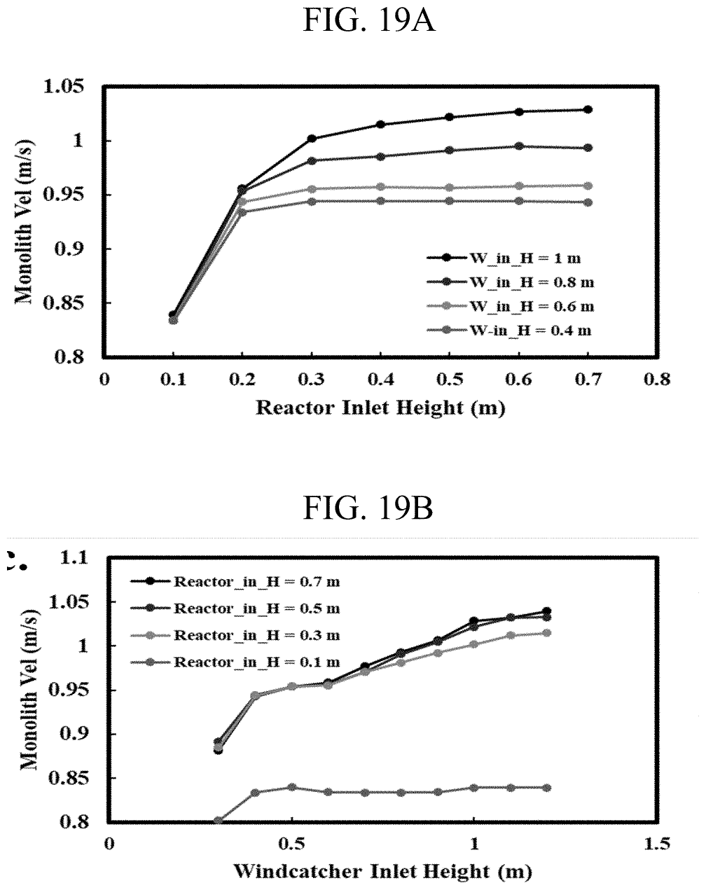

Analysis showed that among all the geometric parameters in the wind catcher section, the reactor inlet height and the wind catcher inlet height might impact the internal flow fields. FIG. 19 presents average monolith velocity (FIGS. 19A and 19B) as a function of reactor inlet height and windcatcher inlet height. There is a sharp increase in the monolith velocity, as the reactor inlet height increases from 10 cm to 30 cm, after which the reactor inlet height does not significantly impact the monolith velocity. For the wind catcher with small reactor inlet height, the monolith velocity did not significantly change with wind catcher inlet height (FIG. 19A). However, at medium and large values of reactor inlet height, the monolith velocity changes from ˜0.9 m/s to ˜1.05 m/s when the wind catcher inlet varies from 0.3 m to 1.2 m (FIGS. 19A and 19B). Although the monolith velocity steadily increases with an increase in wind catcher inlet height, very large values of wind catcher inlet height are not desirable from a practical standpoint due to high air drag and instability applied to the wind catcher. Other geometric parameters were not found to give as significant impact on internal velocity as these two parameters.

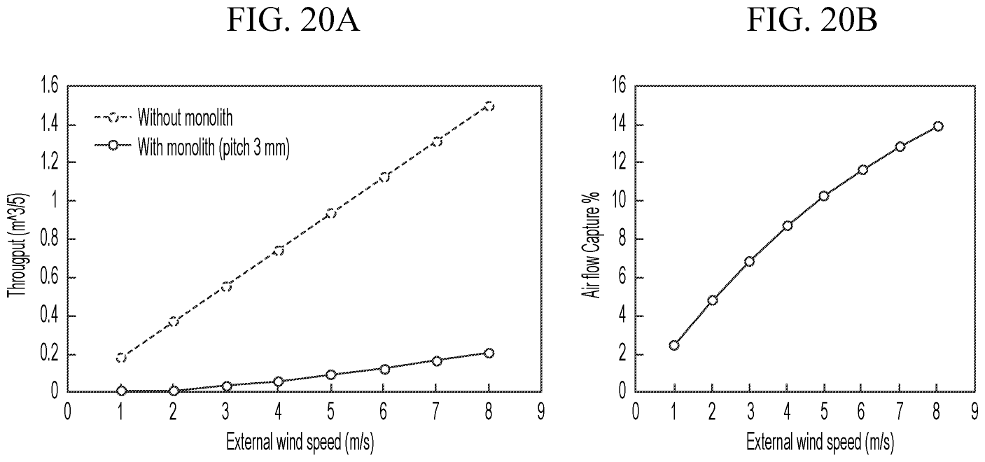

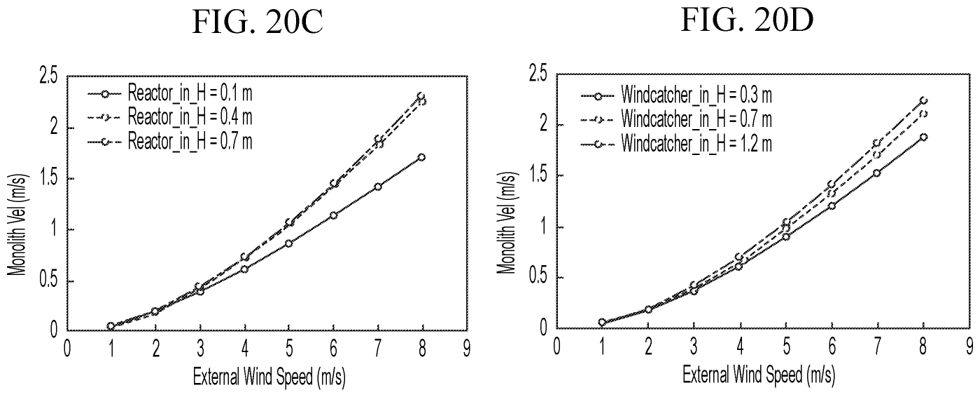

TABLE 2
Model simulation parameters for simulation
cases in FIGS. 19 and 20

| Geometric parameter | Simulated value | |
|---|---|---|
| Wind velocity | 5 | m/s |
| Windcatcher_in_H | Variable | |
| Reactor_in_H | Variable | |
| Windcatcher_W | 80 | cm |
| Channel_H | 30 | cm |
| Monolith_W | 50 | cm |
| Monolith_H | 50 | cm |
| Pitch | 3 | mm |

To determine the effects of external wind velocity on internal flow field, first was compared the air flow into the DAC system with and without the monolith at different external wind speeds ranging from 1-8 m/s. It was found that without the monolith, the throughput (i.e., air flow rate) linearly increases with wind velocity. Upon introduction of the monolith (3 mm pitch), the air flow rate drops significantly and increases non-linearly with wind velocity (FIG. 20A). The calculated air flow capture efficiency (i.e., the ratio of air flow rate with monolith to that without monolith) increases from 2% to 14% as the external wind velocity increases from 1 m/s to 8 m/s, suggesting that higher wind velocities are more conducive to directing a larger proportion of incoming wind into the DAC system (FIG. 20B). This results in non-linear growth in monolith velocity with an increase in external wind velocity for virtually all values of the reactor inlet height and wind catcher inlet height (FIGS. 20C and 20D).

### Monolith Body System

It was also addressed how the monolith the pressure drop along the monolith height increases with an increase in wind speed. A wall thickness of 50 μm is typical of metallic monolith, and the one of a few hundred μm is typical of ceramic monolith. Therefore, when the thicknesses in a range of 50-2,000 μm can cover almost all monoliths made of different materials. Here, it is shown that the wall thickness of the monolith does not play a major role in the resulting pressure drop along the monolith height as the pitch size does (FIG. 14).

1. A sorbent for carbon dioxide removal from ambient air comprising silica, a carbonaceous material, and an epoxy modified aminopolymer.

2. The sorbent of claim 1, wherein the silica is a combination of fumed silica and colloidal silica.

3. The sorbent of claim 2, wherein the weight ratio of fumed silica to colloidal silica is from 80:20 to 99:1.

4. The sorbent of claim 2, wherein the weight ratio of fumed silica to colloidal silica is 95:5.

5. The sorbent of claim 1, wherein the carbonaceous material is selected from the group consisting of graphite, graphene, coal, coke, nanotubes, fullerenes, and activated carbon.

6. The sorbent of claim 1, wherein the carbonaceous material is from 1 to 15 wt % of the sorbent.

7. The sorbent of claim 1, wherein the epoxy modified aminopolymer comprises an epoxy moiety selected from 1,2 epoxypentane, 1,2 epoxyhexane, 1,2 epoxypropane (EP) or 1,2 epoxybutane (EB); and an aminopolymer selected from pentaethylene hexamine (PEHA) or polyethylenimine (PEI).

8. The sorbent of claim 1, wherein the silica is from 20 to 80 wt % of the sorbent.

9. The sorbent of claim 1, wherein the epoxy modified aminopolymer is from 20 to 80 wt % of the sorbent.

10. The sorbent of claim 1, wherein the epoxy modified aminopolymer is PEI, wherein the PEI has a molecular weight of from 100 to 2000 daltons.

11. The sorbent of claim 1, wherein the sorbent has a mean particle size of 10 to 300 μm.

12. The sorbent of claim 1, further comprising 1 to 15 wt % graphite and wherein the epoxy-modified aminopolymer is selected from EB-PEI, EB-PEHA, EP-PEI, EP-PEHA, or any combination thereof.

13. A method for removing CO₂ from ambient air comprising providing a flow of ambient air across the sorbent of claim 1.

14. A method for regenerating the sorbent of claim 1, comprising heating the sorbent to above 70° C. at below 0.9 atm and flowing CO₂ or steam across the sorbent.

15. A system for removing CO₂ from ambient air, comprising the sorbent of claim 1.

16. The system of claim 15, further comprising a wind collector comprised of a truncated cone with a first face and a second face, wherein the first face is wider than the second face and is oriented toward an ambient air source; and
a body comprised of a length, an upper end, and a lower end, wherein the upper end is configured to receive ambient air from the second face of the wind collector and wherein the lower end is open or comprises at least one outlet to allow ambient air to escape the system;
wherein the sorbent is dispersed along the length of the body.

17. The system of claim 16, wherein the body further comprises a monolith comprised of hollowed polyhedron prisms oriented to allow ambient air to flow therethrough from the upper end to the lower end and wherein the sorbent is coated at least partially on an internal surface of at least one hollowed polyhedron prism.

18. The system of claim 16, wherein the body further comprises at least one platform comprised of a fabric, wherein the sorbent is coated at least partially on an exterior surface thereof.

19-34. (canceled)
